(19) United States
(12) Patent Application Publication
(10) Pub. No.: US 2025/0134296 A1
(43) Pub. Date: May 1, 2025

(54) BEVERAGE BREWING APPARATUS FOR EXTRACTING BEVERAGE FROM RAW MATERIAL PUT IN FILTER

(71) Applicant: SOON TACK LEE, Seoul (KR)

(72) Inventor: SOON TACK LEE, Seoul (KR)

(21) Appl. No.: 18/682,818

(22) PCT Filed: Aug. 9, 2022
(86) PCT No.: PCT/KR2022/011835

§ 371 Date: Feb. 9, 2024

(30) Foreign Application Priority Data
Aug. 10, 2021 (KR) 10-2021-0104934
Sep. 3, 2021 (KR) 10-2021-0118005

(51) Int. Cl. A47J 31/06; A47J 31/02

(52) U.S. Cl. CPC A47J 31/0605; A47J 31/02

(57) ABSTRACT

Disclosed is a beverage brewing apparatus, which has a relatively simple configuration and structure to control an outlet to be opened and closed, is convenient to clean, and allows a user to check the amount of beverage in a cup for holding an extracted beverage even when the cup is opaque.

### TECHNICAL FIELD

The disclosure relates to a beverage brewing apparatus that extracts a beverage from a raw material put in a filter. Here, the raw material to be put in the filter may include coffee beans, coffee powder, and leaves, stems, roots and/or fruits of plants.

### BACKGROUND ART

People enjoy drinking a beverage such as coffee or tea. The coffee is made by mixing coffee powder with water, and the tea is made by mixing leaves, stems, roots and/or fruits of various plants with water. However, when people drink such a beverage, they drink only an extracted liquid and do not eat a filtered-out raw material such as the coffee powder or the leaves, stems, etc. of the plants filtered out for the beverage.

Although there are many methods of extracting the beverage from the raw materials, a relatively simple method of putting a raw material into a funnel-shaped filter and pouring water over the raw material to extract the beverage has been widely used. Here, the filter may be made of one selected from among various materials such as paper, fabric, plastic, and metal.

A commercially available beverage brewing apparatus, also known as a dripper, has a problem of difficulty in controlling the concentration of the extracted beverage because an outlet positioned at the bottom of the funnel-shaped filter is always open.

Meanwhile, a clever dripper (trade name), which is sold in many countries including the United States, has a function of opening and closing the outlet, but needs a relatively large number of parts and a complex structure, thereby having disadvantages of being inconvenient to clean and increasing manufacturing costs and selling prices. Further, if a cup for holding a beverage drained out of the dripper is opaque, it is difficult to check the amount of beverage in the cup.

### Technical Problem

An aspect of the disclosure is to provide a beverage brewing apparatus, which has a relatively simple configuration and structure to control an outlet to be opened and closed, is convenient to clean, and allows a user to check the amount of beverage in a cup for holding an extracted beverage even when the cup is opaque.

### Technical Solution

According to an embodiment of the disclosure, a beverage brewing apparatus for extracting a beverage from a raw material put in a filter includes: a base unit including a circular opening, an extension extending radially and outwardly from the opening and including a vertical through portion vertically penetrating the extension in a region of an opening edge tangent to the opening, a rotation blocking portion extending downwards from the opening edge positioned being spaced apart at a predetermined distance from the vertical through portion along a circumferential direction, and a closing portion extending radially and inwardly from the rotation blocking portion; and a main body including a funnel-shaped filter holder with the filter inserted to put the raw material therein, a sliding protrusion protruding radially and outwardly from a lower portion of the filter holder and inserted in the vertical through portion, and an outlet formed vertically penetrating a bottom of the filter holder and movable between a closed position where the outlet is closed by the closing portion as the sliding protrusion is inserted in the vertical through portion and rotated toward the rotation blocking portion in the circumferential direction and an open position where the outlet is away from the closing portion as the sliding protrusion is rotated from the closed position in a counter direction to the circumferential direction.

Here, the main body includes a circular insertion portion extending radially and outwardly from the lower portion of the filter holder and inserted in the opening, the insertion portion includes a peephole formed penetrating the insertion portion to communicate with the opening, and the sliding protrusion protrudes radially and outwardly from the insertion portion, thereby ensuring that the main body is relatively stably mounted to the base unit, and, nevertheless, allowing a user to check the amount of beverage in a cup placed under the base unit through the peephole in person with his/her naked eyes.

Further, the base unit includes a rotation sliding guide that extends downwards from the opening edge corresponding to a circumferential section between the vertical through portion and the rotation blocking portion and comes into contact with an upper surface of the sliding protrusion when the sliding protrusion rotates, thereby allowing a user to rotate the main body relative to the base unit relatively stably without shaking in the vertical direction.

In addition, the rotation sliding guide includes a slope that slopes downwards from the vertical through portion toward the rotation blocking portion in at least some sections, thereby causing the outlet to be more strongly pressed against the closing portion when the main body is rotated in the circumferential direction, and thus preventing or minimizing the leakage of the beverage through the outlet when the outlet is in the closed position.

Further, the outlet is disposed to be spaced apart at a predetermined distance from a virtual line that connects a rotation axis of the main body and the sliding protrusion, thereby improving durability of the closing portion because the region of the closing portion, in which the outlet is positioned, is directly supported by the rotation blocking portion at a relatively close distance from the rotation blocking portion when the main body rotates relative to the base unit until the sliding protrusion is in contact with the rotation blocking portion. On the other hand, if the outlet is positioned on the virtual line that connects the rotation axis of the main body and the sliding protrusion, the closing portion, in which the outlet is positioned, is relatively far from the rotation blocking portion, and thus likely to be bent or damaged, thereby resulting in relatively weak durability.

In addition, the base unit includes a counter-rotation blocking portion extending downwards from the opening edge positioned being spaced apart at a predetermined distance from the vertical through portion along a counter direction to the circumferential direction, and the outlet is in the open position as the sliding protrusion is inserted in the vertical through portion and rotated toward the counter-rotation blocking portion, thereby preventing excessive rotation when the main body is rotated relative to the base unit in the counter direction to the circumferential direction, and making it useful to ensure that the outlet remains open according to the types or tastes of beverage to be extracted.

### Advantageous Effects

According to the disclosure, the beverage brewing apparatus has a relatively simple configuration and structure to control an outlet to be opened and closed, is convenient to clean, and allows a user to check the amount of beverage in a cup for holding an extracted beverage even when the cup is opaque.

### DESCRIPTION OF DRAWINGS

FIG. 1 is a coupled perspective view showing that a beverage brewing apparatus according to the disclosure rests on a cup,

FIG. 2 is an exploded perspective view of the beverage brewing apparatus of FIG. 1,

FIG. 3 is a perspective view of a main body viewed from above,

FIG. 4 is a perspective view of the main body viewed from below,

FIG. 5 is a perspective view of a base unit viewed from above,

FIG. 6 is a perspective view of the base unit viewed from below,

FIGS. 7 to 9 illustrate that the open and closed states of an outlet when the main body is rotated clockwise relative to the base unit, and

FIG. 10 illustrates that the open and closed state of the outlet when the main body is rotated counterclockwise relative to the base unit.

### BEST MODE

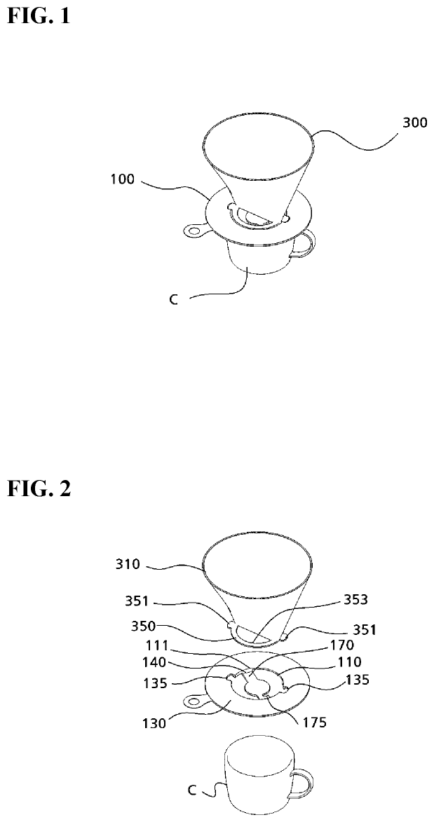

FIG. 1 is a coupled perspective view showing that a beverage brewing apparatus according to the disclosure rests on a cup C, and FIG. 2 is an exploded perspective view of the beverage brewing apparatus of FIG. 1. As shown in FIGS. 1 and 2, the beverage brewing apparatus includes a base unit 100 resting on the top of a cup C, and a main body 300 detachably coupled to the base unit 100.

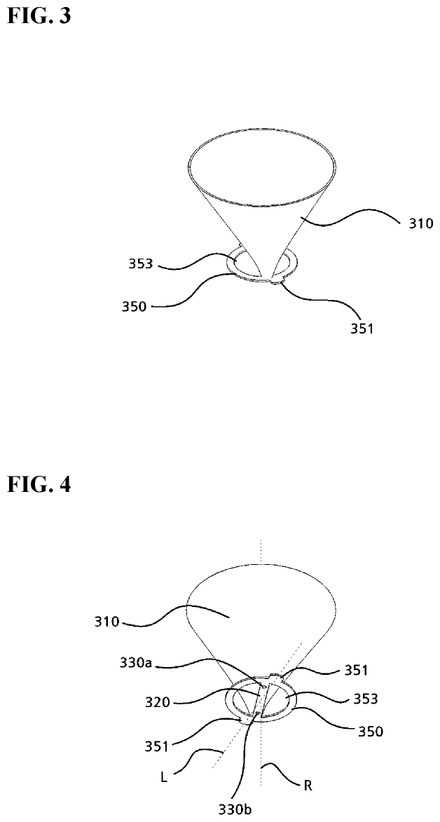

FIG. 3 is a perspective view of the main body 300 viewed from above, and FIG. 4 is a perspective view of the main body 300 viewed from below. As shown in FIGS. 3 and FIG. 4, the main body 300 includes a funnel-shaped filter holder 310, a circular insertion portion 350 extending radially and outwardly from a lower portion of the filter holder 310, a sliding protrusion 351 protruding radially and outwardly from an outer circumference of the insertion portion 350, and a pair of outlets 330a and 330b vertically penetrating a bottom 320 of the filter holder 310.

The filter holder 310 is shaped like a funnel of which the top is circular and the bottom 320 is linear. The shape of the filter holder 310 may be varied depending on various types of commercially available filters. The pair of outlets 330a and 330b are disposed on both sides with respect to the center of the linear bottom 320 as being spaced apart at a predetermined distance from each other. In addition, the pair of outlets 330a and 330b are disposed to be spaced apart at a predetermined distance from a virtual line L connecting a rotation axis R of the main body 300 and the sliding protrusions 351. The circular insertion portion 350 includes peepholes 353 formed penetrating the circular insertion portion 350 in a vertical direction. The sliding protrusion 351 may extend radially and outwardly from the outer circumference of the bottom 320, and in this case the insertion portion 350 may not be present.

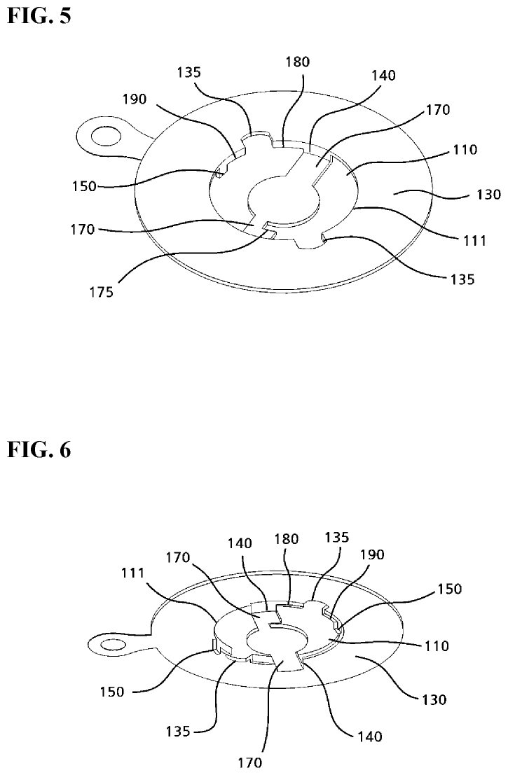

FIG. 5 is a perspective view of the base unit 100 viewed from above, and FIG. 6 is a perspective view of the base unit 100 viewed from below. As shown therein, the base unit 100 includes a circular opening 110 positioned at the center thereof, and an extension 130 extending radially and outwardly with respect to the opening 100. The extension 130 includes a pair of vertical through portions 135 vertically penetrating the extension 130 in regions of an opening edge 111 tangent to the opening 110 and facing each other. Here, the opening 110 refers to a hollow through space, and the opening edge 111 refers to the edge of the opening 110 where the extension 130 starts, the rim of the opening 110, or a portion abutting on the opening 110.

In addition, the base unit 100 includes a pair of rotation blocking portions 140 extending downwards from the opening edge 111 positioned being spaced apart at a predetermined distance from the vertical through portion 135 along a circumferential direction, and a pair of closing portions 170 extending radially and inwardly from the respective rotation blocking portions 140. Here, the circumferential direction may refer to a clockwise direction or a counterclockwise direction. In the accompanying drawings, the circumferential direction is represented as the clockwise direction. One of the pair of closing portions 170 is formed with a partial through portion 175 formed penetrating a portion of the closing portion 170. The pair of closing portions 170 facing each other may or may not be connected to each other. Further, the base unit 100 includes a rotation sliding guide 180 extending downwards from the opening edge 111 corresponding to a circumferential section between the vertical through portion 135 and the rotation blocking portion 140.

The rotation sliding guide 180 comes into contact with an upper surface of the sliding protrusion 351 when the sliding protrusion 351 rotates being inserted in the vertical through portion 135, so that the main body 300 can rotate relative to the base unit 100 relatively stably without shaking in the vertical direction.

The base unit 100 includes a pair of counter-rotation blocking portions 150 extending downwards from the opening edge 111 positioned being spaced apart at a predetermined distance from the vertical through portion 135 along a counter direction to the circumferential direction. In other words, when the rotation blocking portion 140 is spaced apart from the vertical through portion 135 in the clockwise direction, the counter-rotation blocking portion 150 is spaced apart from the vertical through portion 135 in the counterclockwise direction.

The base unit 100 includes a counter-rotation sliding guide 190 extending downwards from the opening edge 111 corresponding to a circumferential section between the vertical through portion 135 and the counter-rotation blocking portion 150.

The counter-rotation sliding guide 190 comes into contact with the upper surface of the sliding protrusion 351 when the sliding protrusion 351 rotates being inserted in the vertical through portion 135, so that the main body 300 can rotate relative to the base unit 100 relatively stably without shaking in the vertical direction.

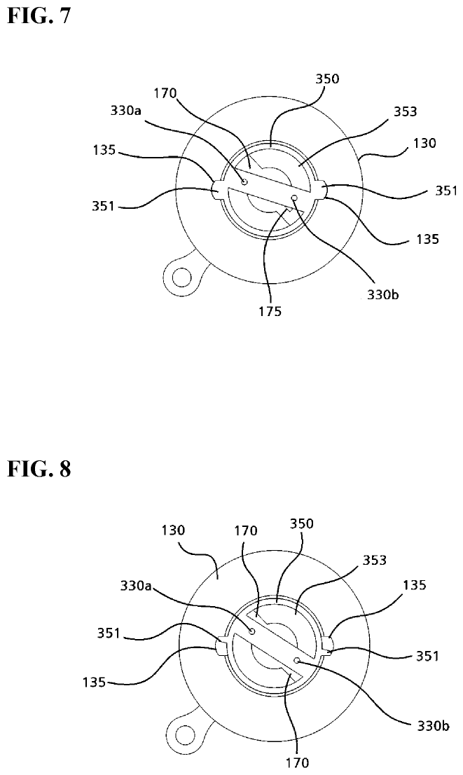

FIGS. 7 to 9 illustrate that the open and closed states of the outlets 330a and 330b when the main body 300 is rotated clockwise relative to the base unit 100. FIG. 7 shows when the sliding protrusion 351 of the main body 300 is inserted in the vertical through portion 135 of the base unit 100. In this case, the main body 300 is supported by the closing portion 170, and the pair of outlets 330a and 330b are all in an open position away from the closing portion 170.

FIG. 8 shows the open and closed states of the outlets 330a and 330b when the main body 300 is rotated from the state of FIG. 7 at a predetermined angle with respect to the base unit 100. In this case, one 330a of the pair of outlets 330a and 330b is in a closed position where it is closed by the closing portion 170, and the other 330b is in the open position where it is disposed corresponding to the partial through hole 175.

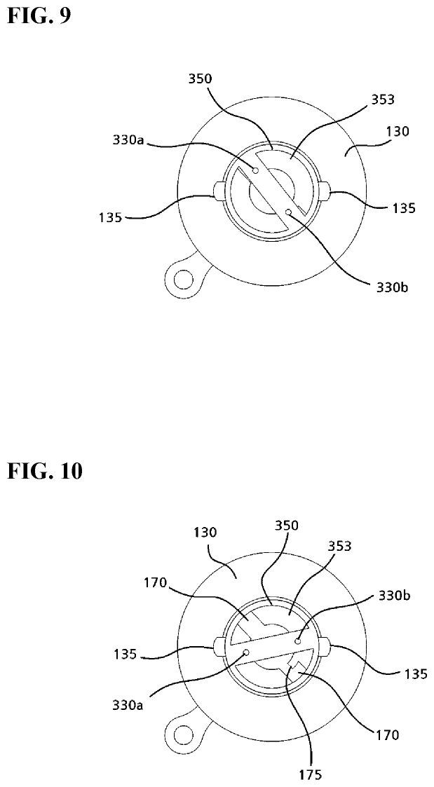

FIG. 9 shows the open and closed states of the outlets 330a and 330b when the main body 300 is further rotated from the state of FIG. 8 at a predetermined angle with respect to the base unit 100. In this case, the pair of outlets 330a and 330b are all in the closed position corresponding to the closing portion 170. The state shown in FIG. 9 may be the sate when the sliding protrusion 351 is rotated and comes into contact with the rotation blocking portion 140. In this state where both the outlets 330a and 330b are closed, water is not drained out of the outlets 330a and 330b even when water is poured into the funnel-shaped the filter holder 310.

To prevent water from leaking through the outlets 330a and 330b when the outlets 330a and 330b are in the closed position, the rotation sliding guide 180 may include a slope that slopes downwards from the vertical through portion 135 toward the rotation blocking portion 140. This slope causes the outlets 330a and 330b to be progressively and more strongly pressed against an upper surface of the closing portion 170.

FIG. 10 illustrates that the open and closed state of the outlets 330a and 330b when the main body 300 is rotated counterclockwise relative to the base unit 100. FIG. 10 shows the state when the sliding protrusion 351 is rotated from the state of FIG. 7 toward the counter-rotation blocking portion 150. In this state, the pair of outlets 330a and 330b are all open.

The counter-rotation sliding guide 190 may have a counter-slope that slopes downwards from the vertical through portion 135 toward the counter-rotation blocking portion 150, so that the outlets 330a and 330b can be held in the open position. This counter-slope causes the insertion portion 350 and the bottom 320 to be more strongly pressed against the closing portion 170, so that the main body 300 can be fixed not to move relative to the base unit 100 while the outlets 330a and 330b are open.

In this way, the beverage brewing apparatus according to the disclosure has a simple configuration and structure of the main body 300 and the base unit 100 to open and close the outlets 330a and 330b and is convenient to clean.

In addition, as shown in FIGS. 7 to 10, the amount of beverage in the cup C placed under the base unit 100 is checkable through the peephole 353 communicating with the opening 110 even when the main body 300 is mounted to the base unit 100.

1. A beverage brewing apparatus for extracting a beverage from a raw material put in a filter, comprising:
a base unit comprising a circular opening, an extension extending radially and outwardly from the opening and comprising a vertical through portion vertically penetrating the extension in a region of an opening edge tangent to the opening, a rotation blocking portion extending downwards from the opening edge positioned being spaced apart at a predetermined distance from the vertical through portion along a circumferential direction, and a closing portion extending radially and inwardly from the rotation blocking portion; and
a main body comprising a funnel-shaped filter holder with the filter inserted to put the raw material therein, a sliding protrusion protruding radially and outwardly from a lower portion of the filter holder and inserted in the vertical through portion, and an outlet formed vertically penetrating a bottom of the filter holder and movable between a closed position where the outlet is closed by the closing portion as the sliding protrusion is inserted in the vertical through portion and rotated toward the rotation blocking portion in the circumferential direction and an open position where the outlet is away from the closing portion as the sliding protrusion is rotated from the closed position in a counter direction to the circumferential direction.

2. The beverage brewing apparatus of claim 1, wherein
the main body comprises a circular insertion portion extending radially and outwardly from the lower portion of the filter holder and inserted in the opening,
the insertion portion comprises a peephole formed penetrating the insertion portion to communicate with the opening, and
the sliding protrusion protrudes radially and outwardly from the insertion portion.

3. The beverage brewing apparatus of claim 1, wherein the base unit comprises a rotation sliding guide that extends downwards from the opening edge corresponding to a circumferential section between the vertical through portion and the rotation blocking portion and comes into contact with an upper surface of the sliding protrusion when the sliding protrusion rotates.

4. The beverage brewing apparatus of claim 3, wherein the rotation sliding guide comprises a slope that slopes downwards from the vertical through portion toward the rotation blocking portion in at least some sections.

5. The beverage brewing apparatus of claim 1, wherein the outlet is disposed to be spaced apart at a predetermined distance from a virtual line that connects a rotation axis of the main body and the sliding protrusion.

6. The beverage brewing apparatus of claim 1, wherein
the base unit comprises a counter-rotation blocking portion extending downwards from the opening edge positioned being spaced apart at a predetermined distance from the vertical through portion along a counter direction to the circumferential direction, and
the outlet is in the open position as the sliding protrusion is inserted in the vertical through portion and rotated toward the counter-rotation blocking portion.
